(19) United States
(12) Patent Application Publication
(10) Pub. No.: US 2014/0110237 A1
(43) Pub. Date: Apr. 24, 2014

(54) PUSH SWITCH

(71) Applicant: PANASONIC CORPORATION, Osaka (JP)

(72) Inventors: Masatoshi ENOMOTO, Okayama (JP); Yuki HIRATA, Okayama (JP)

(73) Assignee: PANASONIC CORPORATION, Osaka (JP)

(21) Appl. No.: 14/051,279

(22) Filed: Oct. 10, 2013

(30) Foreign Application Priority Data
Oct. 18, 2012 (JP) 2012-230708

(51) Int. Cl. H01H 13/14

(52) U.S. Cl. CPC H01H 13/14
USPC 200/513

(57) ABSTRACT

A push switch comprises a first stationary contact, a second stationary contact disposed apart from the first stationary contact, and a movable contact unit confronting the first stationary contact with a space therebetween. The movable contact unit includes a center portion and a surrounding portion, the center portion has a dome-like shape, and the surrounding portion is formed in a peripheral region of the center portion.

### BACKGROUND

1. Technical Field

The present invention relates to push switches for use in input control sections of various electronic apparatuses.

2. Background Art

Various kinds of push switches are used in input control sections of various electronic apparatuses. For example, quite a number of double-action push switches are used for shutter functions of cameras. When a double-action push switch is depressed, a first switch operates first, and a second switch operates thereafter when it is depressed further down.

Referring to FIG. 6 through FIG. 9, description is provided of a conventional double-action push switch. FIGS. 6, 8 and 9 are sectional views of conventional push switch, and FIG. 7 is an exploded perspective view of the switch of FIG. 6. FIG. 8 shows the conventional push switch of a state in which a first switch is turned on, and FIG. 9 shows another state in which a second switch is turned on.

Case 1 made of an insulation resin has a recess as shown in FIG. 7. The recess is open to an upper side. Center contact 2 (i.e., first stationary contact) is fixed to a center position in the recess of case 1. Side contacts 3 and 4 (i.e., second stationary contacts) are also fixed inside the recess of case 1. Side contacts 3 and 4 are disposed independently of each other at two positions that are point symmetrical about center contact 2. Center contact 2 is connected with second terminal 5 (refer to FIG. 7) which protrudes outward from case 1. Side contacts 3 and 4 are connected with first terminals 6 and 7 (refer to FIG. 7) respectively, which also protrude outward from case 1.

The recess of case 1 has such a shape that it is formed of a circular recess provided with four extended portions (i.e., grooves 8). Grooves 8 are formed radially from the center of the recess at uniform angles of 90 degrees.

To begin with, description is provided of first movable contact 10.

First movable contact 10 is made of a thin plate-like elastic metal. A shape of first movable contact 10 is configured of annular portion 12 and four extended portions 13. Annular portion 12 has a shape of circular ring with center opening 11 of a round form. Extended portions 13 extend obliquely downward from the outer edge of annular portion 12. First movable contact 10 has an upwardly curved shape (or, dome-like shape). When first movable contact 10 is depressed from above annular portion 12, a physical configuration of it changes from a state of FIG. 6 to another state shown in FIG. 8. When a depressing force exceeds a given amount, upwardly curved first movable contact 10 deforms elastically in a manner to warp downward (the state of FIG. 8).

Each of four extended portions 13 of first movable contact 10 is disposed in their corresponding one of grooves 8 in case 1. A lower face of annular portion 12 is located above side contacts 3 and 4 (second stationary contacts) with a predetermined space maintained between them.

Description is provided next about second movable contact 15.

Second movable contact 15 is made of a thin plate-like elastic metal. Second movable contact 15 has an upwardly convexed shape (dome-like shape). In addition, second movable contact 15 has a round shape in a plan view. An outer edge of second movable contact 15 overlaps with an outer edge of annular portion 12 of first movable contact 10 in the plan view. A lower side of the outer edge of second movable contact 15 abuts on an upper side of the outer edge of annular portion 12. The lower face in a center portion of second movable contact 15 is located above center contact 2 (first stationary contact) with a predetermined space through center opening 11 of annular portion 12.

When a center portion of second movable contact 15 is depressed with a force exceeding a given amount, the upwardly convexed second movable contact 15 deforms elastically in a manner to warp downward with a tactile click. In other words, its physical configuration changes from the state of FIG. 8 to another state of FIG. 9.

Here, the depressing force to make second movable contact 15 deform elastically and warp downward is larger than the depressing force to make first movable contact 10 deform elastically to warp downward. In addition, a force of second movable contact 15 to regain its original state is larger than a force of first movable contact 10 to regain its original state.

Flexible protective sheet 17 is disposed to cover the upper side of the recess in case 1. Protective sheet 17 is formed of a film of insulation resin. In addition, cover 19 made of a metal sheet is attached to case 1 in position above case 1. Cover 19 has through-hole 20 formed in a center portion thereof.

In the conventional push switch constructed as above, first movable contact 10 and second movable contact 15 constitute a movable contact unit, and side contacts 3 and 4 and center contact 2 constitute a stationary contact unit.

The conventional push switch operates in a manner which is described next.

When a part of protective sheet 17 exposed from through-hole 20 of cover 19 is depressed, a force of the depression is applied to both second movable contact 15 and first movable contact 10 through protective sheet 17. When the depressing force applied to protective sheet 17 exceeds a given amount, the dome-shaped portion of first movable contact 10 elastically deforms first into the downwardly convexed shape with a tactile click. As a result of the elastic deformation of the dome-shaped portion, a lower face of annular portion 12 comes into contact with confronting contacts 3 and 4, as shown in FIG. 8. In other words, first terminals 6 and 7 turn into electrically continuous, and the first switch becomes an ON state at this time. Second movable contact 15 remains in the upwardly convexed dome-like shape at this moment.

When protective sheet 17 is depressed further down, second movable contact 15 elastically deforms and warps downward with a tactile click, as shown in FIG. 9. This causes the lower face in the center portion of second movable contact 15 to come into contact with center contact 2 through center opening 11 of first movable contact 10. At this moment, first movable contact 10 is still in the state of electrical continuity with side contacts 3 and 4. First terminals 6 and 7 and second terminal 5 thus become electrically continuous as a result of having second movable contact 15 come into contact with center contact 2, and the second switch turns into an ON state.

When the depressing force is removed thereafter, second movable contact 15 reverts to the upwardly convexed dome-like shape (i.e., original state) with a tactile click. Second movable contact 15 then separates from center contact 2, so that second terminal 5 is electrically isolated from first terminals 6 and 7.

Subsequently, first movable contact 10 reverts to the upwardly convexed dome-like shape (i.e., original state) with a tactile click. The lower face of annular portion 12 of first movable contact 10 thus separates from side contacts 3 and 4, so that first terminals 6 and 7 are electrically isolated from each other. Push switch returns to the normal state (i.e., the state of FIG. 6) in which no depressing force is being applied.

Patent literature 1 is one example of the prior art documents known to be related to the present invention in this application (e.g., Unexamined Japanese Patent Publication No. 2008-41603).

### SUMMARY

A primary aspect of the present invention is a push switch configured to cause a movable contact unit to deform elastically to establish continuity between a first stationary contact and a second stationary contact through the movable contact unit, and that the push switch comprises the first stationary contact, the second stationary contact disposed apart from the first stationary contact, and the movable contact unit confronting the first stationary contact with a space between them. The movable contact unit includes a center portion and a surrounding portion. The center portion has a dome-like shape, and the surrounding portion is formed along a peripheral region of the center portion. The above are distinctive features provided by the present invention.

Thus achieved by virtue of the above structure is to increase a moving distance that brings the movable contact unit into elastic deformation, thereby extending an operating stroke.

### BRIEF DESCRIPTION OF DRAWINGS

FIG. 1 is a sectional view of a push switch according to first exemplary embodiment of the present invention.

FIG. 2A is an exploded perspective view of the push switch according to the first exemplary embodiment of the invention.

FIG. 2B is a perspective view of a second movable contact of the push switch according to the first exemplary embodiment of the invention.

FIG. 2C is a top view of the second movable contact shown in FIG. 2B.

FIG. 2D is a top view of another second movable contact of the push switch according to the first exemplary embodiment of the invention.

FIG. 2E is a perspective view of still another second movable contact of the push switch according to the first exemplary embodiment of the invention.

FIG. 2F is a top view of the second movable contact shown in FIG. 2E.

FIG. 2G is a top view of a second movable contact of the push switch according to second exemplary embodiment of the invention.

FIG. 3 is a sectional view of the push switch according to the first exemplary embodiment of the invention.

FIG. 4 is another sectional view of the push switch according to the first exemplary embodiment of the invention.

FIG. 5 is a graphic chart showing a tactile curve of the push switch of the first exemplary embodiment of this invention.

FIG. 6 is a sectional view of a conventional push switch.

FIG. 7 is an exploded perspective view of the conventional push switch.

FIG. 8 is a sectional view of the conventional push switch.

FIG. 9 is another sectional view of the conventional push switch.

### DESCRIPTION OF EMBODIMENTS

Description is provided of a drawback associated with conventional push switches before going into details of exemplary embodiments.

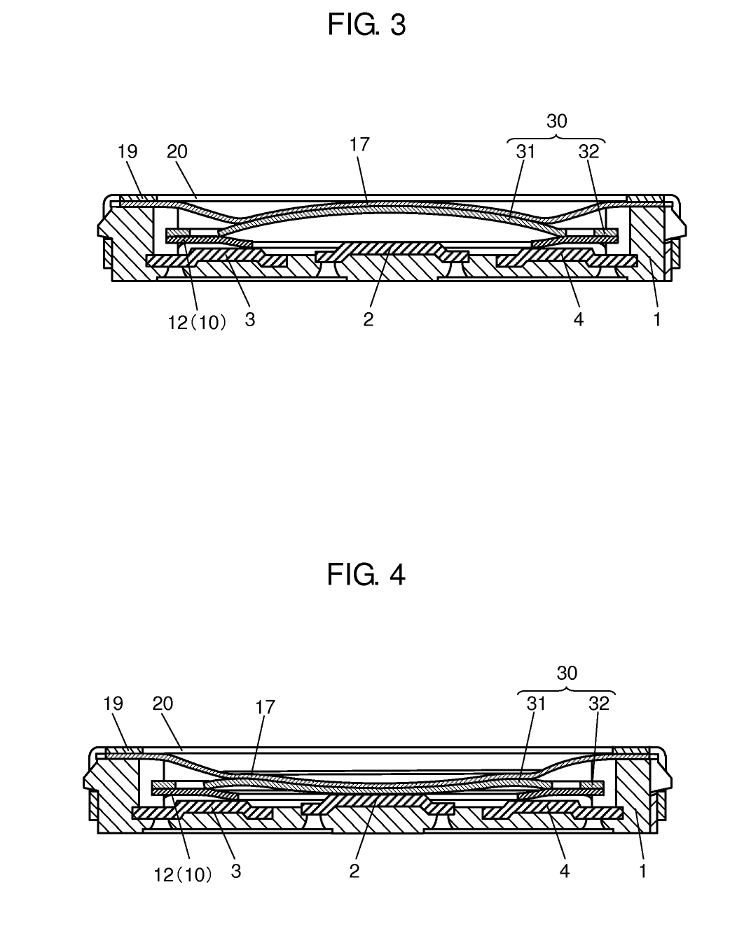

The conventional push switch shown in FIG. 6 has a lower end of a peripheral edge of second movable contact 15 disposed above a peripheral edge of annular portion 12. During a first stage operation of the push switch, the lower end of the peripheral edge of second movable contact 15 depresses the annular portion 12. A force of this depression causes first movable contact 10 to deform elastically into a downwardly warped shape (dome-like shape). According to this conventional structure, an operating stroke in the first stage of push switch is short, and there has been a demand for increasing the operating stroke in the first stage of push switch to obtain a positive feeling of depressing manipulation even in the first stage operation of the push switch.

The present invention addresses such a problem of the conventional art, and aims at providing a push switch of which an operating stroke in the first stage of the push switch is longer than that of conventional products.

### FIRST EXEMPLARY EMBODIMENT

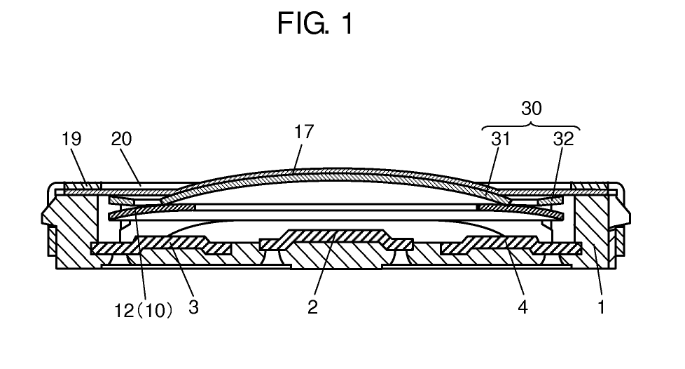

Description is provided hereinafter of the exemplary embodiments of the present invention with reference to FIG. 1 to FIG. 5. Here, components identical to those of the conventional art are denoted by the same reference marks, and their details will be omitted.

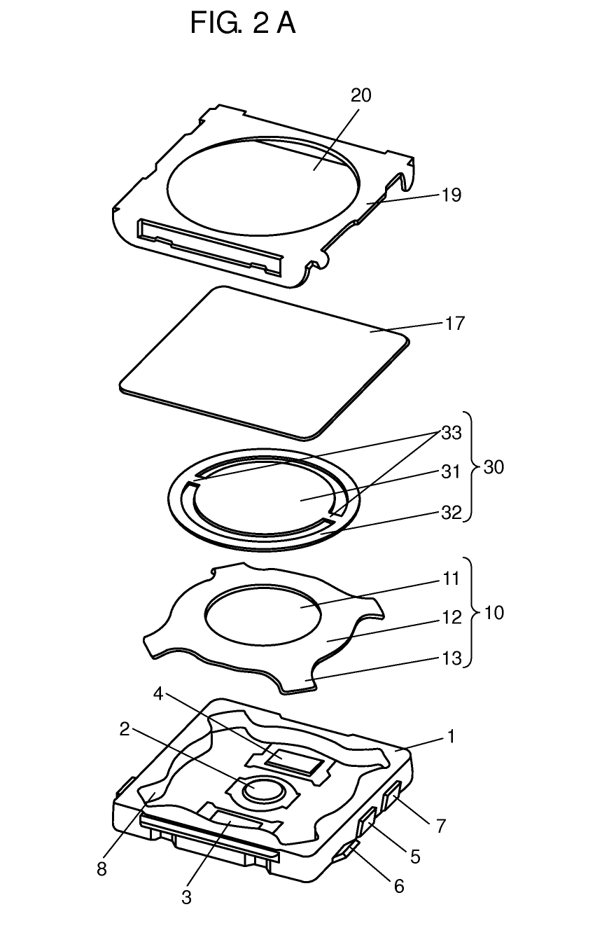

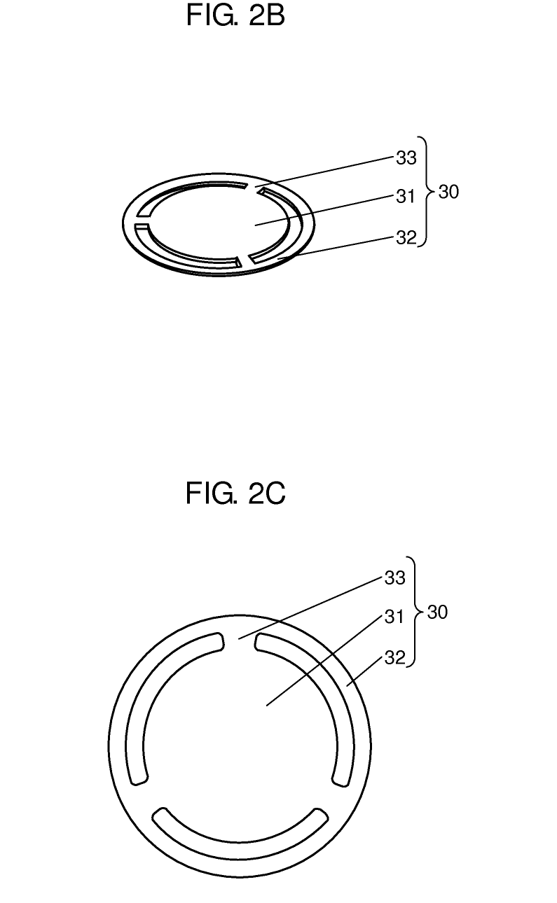

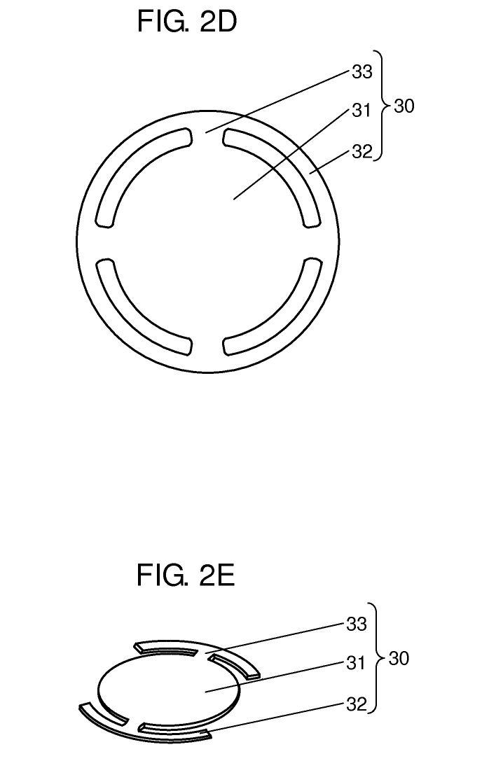

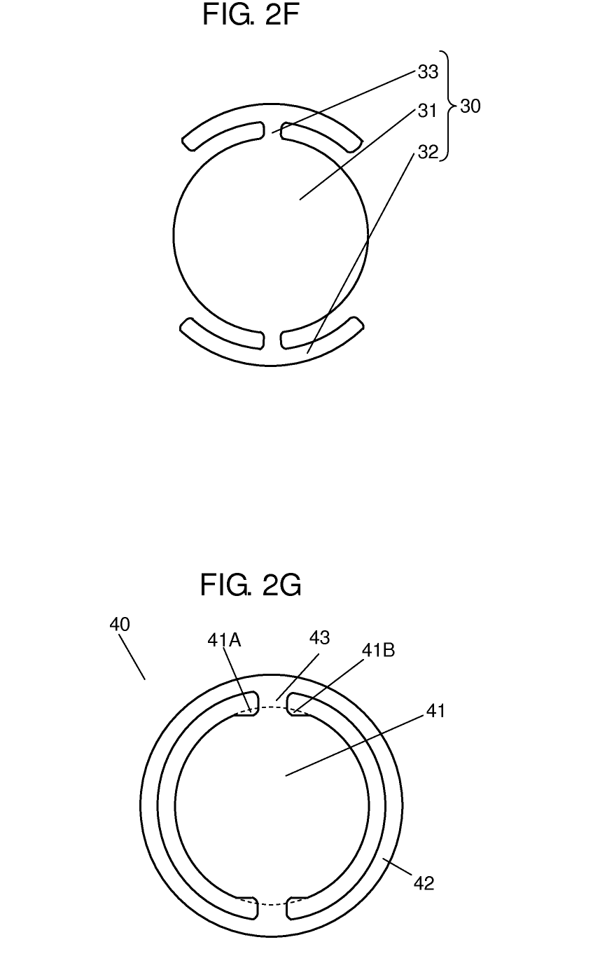

FIGS. 1, 3 and 4 are sectional views of a push switch according to the first exemplary embodiment. FIG. 2A is an exploded perspective view of the push switch shown in FIG. 1. FIG. 3 shows the push switch of a state in which a first switch is turned on, and FIG. 4 shows another state in which a second switch is turned on. FIG. 5 is a graphic chart showing tactile curves.

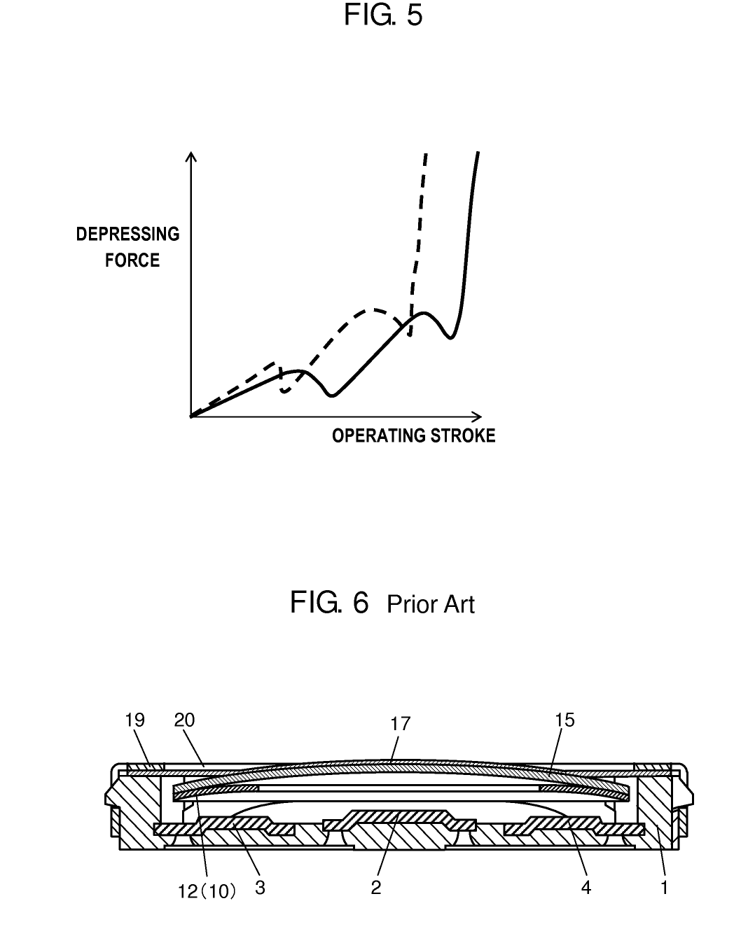

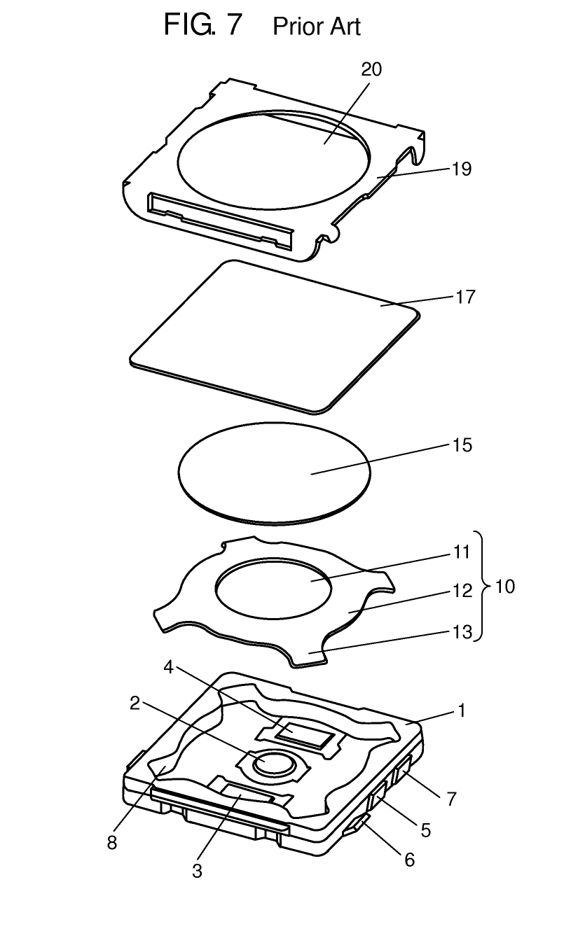

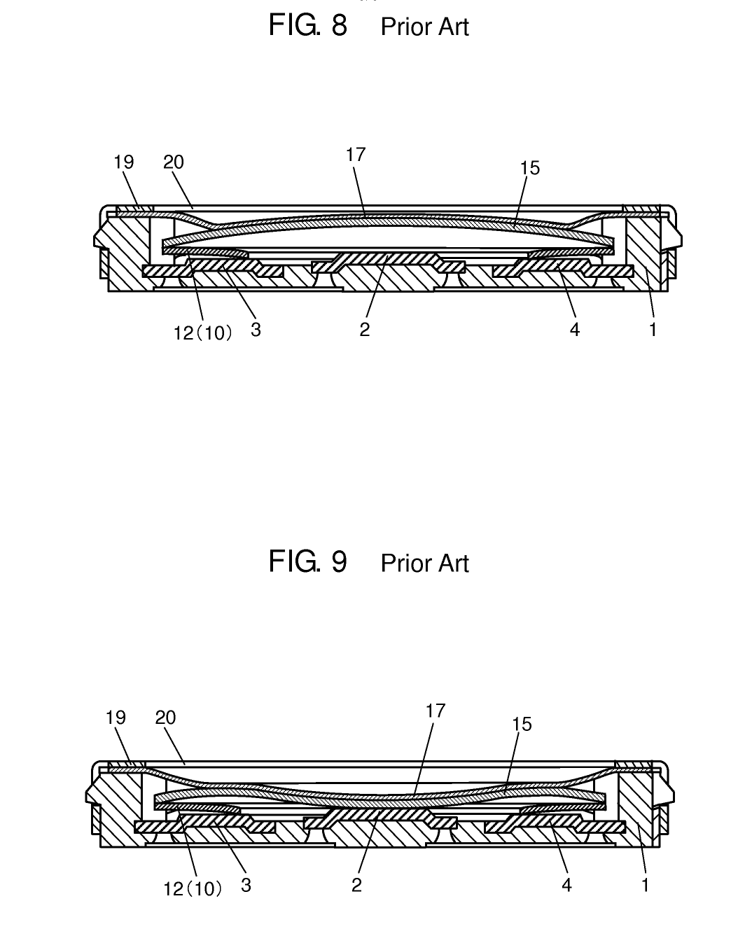

In a structure of the push switch of this embodiment shown in FIG. 1, an item that differs from the conventional push switch described by referring to FIG. 7 is a shape of the second movable contact. Other structures such as case 1, center contact (i.e., first stationary contact) 2, side contacts (i.e., second stationary contacts) 3 and 4, and the like are similar to those of the conventional push switch, they are therefore denoted by the same reference marks, and descriptions of them will be omitted.

Second movable contact 30 of the first exemplary embodiment is described hereinafter in detail.

As shown in FIG. 2A, second movable contact 30 is formed of dome-shaped portion (i.e., center portion) 31, surrounding portion 32, and connecting portions 33. There is a space between dome-shaped portion 31 and surrounding portion 32, and that dome-shaped portion 31 and surrounding portion 32 are connected with connecting portions 33. Dome-shaped portion (center portion) 31 has a dome-like round shape which is upwardly convexed. A diameter of dome-shaped portion 31 is smaller than that of conventional second movable contact 15 (refer to FIG. 7) in a plan view. A center position of surrounding portion 32 coincides with a center position of dome-shaped portion 31 in a top view. Surrounding portion 32 has a circular ring shape, and it encircles the periphery of dome-shaped portion 31. There are two connecting portions 33 formed in an example of FIG. 2A. Two connecting portions 33 are disposed at positions opposite to each other with respect to the center of dome-shaped portion 31 in the top view. A diameter of outer perimeter of surrounding portion 32 is equal to a diameter of second movable contact 15 of the conventional push switch (refer to FIG. 7).

When a center portion in dome-shaped portion 31 of second movable contact 30 is depressed, and when a depressing force exceeds a given amount, dome-shaped portion 31 deforms elastically into a downwardly convexed shape with a tactile click. The depressing force necessary to turn dome-shaped portion 31 into the downwardly convexed shape is larger than a depressing force to make first movable contact 10 deform elastically. In addition, a force required for dome-shaped portion 31 to regain its original state (i.e., upwardly convexed dome-like shape) is larger than a force of second movable contact 30 to regain its original state.

Second movable contact 30 is disposed on top of first movable contact 10. Annular portion 12 of first movable contact 10 rises toward the center in a side view, as shown in FIG. 1. A lower edge of dome-shaped portion 31 abuts on a center side (i.e., inner side than an outer edge of the first movable contact) of annular portion 12 of first movable contact 10. In other words, surrounding portion 32 of second movable contact 30 is not in contact with annular portion 12 under the state that the push switch is not being depressed, as shown in FIG. 1.

Flexible protective sheet 17 is disposed above case 1 in a manner to cover the upper side of a recess of case 1. In addition, cover 19 made of a metal sheet is attached above case 1. Cover 19 has through-hole 20 formed in a center portion thereof.

Here, first movable contact 10 and second movable contact 30 are collectively referred to as a movable contact unit.

The push switch of the first exemplary embodiment operates in a manner which is described next.

When a part of protective sheet 17 exposed from through-hole 20 of cover 19 is depressed, the depressing force is applied to second movable contact 30 and first movable contact 10 through protective sheet 17 in the like manner as in the conventional case. When the depressing force exceeds the given amount, annular portion 12 of first movable contact 10 elastically deforms first, and warps downward with a tactile click. At this time, a lower face of annular portion 12 comes into contact with confronting side contacts 3 and 4 as shown in FIG. 3, and establishes an electrical continuity between first terminals 6 and 7. As a result, the first switch turns into an ON state. At this moment, dome-shaped portion 31 (center portion) of second movable contact 30 remains in the upwardly convexed dome-like shape.

That is, when a first stage of the push switch turns into the ON state (from the state of FIG. 1 to another state of FIG. 3), a lower end of the peripheral edge of dome-shaped portion 31 depresses annular portion 12 of first movable contact 10 and makes annular portion 12 deform elastically to warp downward. At this moment, the lower edge of dome-shaped portion 31 is in contact with a position near the center side of annular portion 12. In the state that push switch is not depressed (the state of FIG. 1), a position of the lower edge of dome-shaped portion 31 is higher than a position of the lower edge of first movable contact 15 (dome-shaped portion) of the conventional push switch described by referring to FIG. 6. A moving distance of the lower edge of dome-shaped portion 31 thus becomes longer during downward warpage of annular portion 12 due to the elastic deformation. In other words, the operating stroke of the push switch becomes longer in this exemplary embodiment than that of the conventional push switch when turning the first stage of push switch into the ON state, thereby providing a positive feeling in the depressing manipulation.

FIG. 5 shows a result of measurement of tactile curves in the depressing manipulation of the push switch of the first exemplary embodiment and the conventional push switch. In FIG. 5, the horizontal axis represents operating stroke and the vertical axis represents depressing force, wherein a tactile curve of the push switch of this embodiment is shown by the solid line, and another tactile curve of the conventional push switch is shown by the dotted line. As is obvious from FIG. 5, the stroke to operate the first switch of the push switch of this embodiment is longer than the stroke of the conventional push switch.

Description is provided next about operation of the second switch.

When the push switch of this embodiment is depressed further down after the ON state of the first switch, dome-shaped portion (center portion) 31 of second movable contact 30 deforms elastically and warps downward with a tactile click, as shown in FIG. 4. A lower face of downwardly warped center portion 31 comes into contact with center contact 2 through center opening 11 of first movable contact 10. Side contacts 3 and 4 are electrically continuous through first movable contact 10 at this moment. Second switch therefore turns into an ON state and establishes an electrical continuity among first terminals 6 and 7 and second terminal 5, when dome-shaped portion 31 comes into contact with center contact 2 under the condition that side contacts 3 and 4 are electrically continuous. At least of a part of outer edge of surrounding portion 32 of second movable contact 30 abuts on an inner wall of the recess of case 1 when the second switch is in the ON state. A position of second movable contact 30 therefore is controlled by the inner wall of the recess and is prevented from becoming displaced in the horizontal direction.

When the depressing force is removed thereafter, dome-shaped portion 31 of second movable contact 30 reverts first into the upwardly convexed original dome-like shape with a tactile click. At the same time, second movable contact 30 separates from center contact 2, so that second terminal 5 is electrically isolated from first terminals 6 and 7. Subsequently, first movable contact 10 reverts to the upwardly warped original state with a tactile click. At the same time, the lower face of annular portion 12 separates from side contacts 3 and 4, and first terminals 6 and 7 are electrically isolated from each other. The push switch of this embodiment thus returns to the normal state shown in FIG. 1, in which no depressing force is being applied. At least of a part of outer edge of surrounding portion 32 of second movable contact 30 abuts on the inner wall of the recess in this state. A position of second movable contact 30 therefore is controlled by the inner wall of the recess and is prevented from becoming displaced in the horizontal direction.

As described above, the push switch of this exemplary embodiment achieves to increase a stroke in the depressing manipulation and provide a positive feeling in the depressing manipulation.

Description is provided next of surrounding portion 32 of second movable contact 30.

Second movable contact 30 of this embodiment described above by referring to FIG. 2A comprises round dome-shaped portion 31, surrounding portion 32, and connecting portions 33. Connecting portions 33 connect dome-shaped portion 31 and surrounding portion 32. Second movable contact 30 having surrounding portion 32 in addition to round dome-shaped portion 31 can prevent it from becoming displaced when compared with an instance in which second movable contact 30 is formed only of dome-shaped portion 31. It is unlikely that displacement occurs in the push switch of this embodiment since at least of a part of outer edge of surrounding portion 32 abuts on the inner wall of the recess of case 1 at all times.

In this exemplary embodiment, an outer diameter of surrounding portion 32 is formed equivalent to that of annular portion 12 of first movable contact 10. Because of this structure, both the outer edge of surrounding portion 32 and the outer edge of annular portion 12 are guided by the inner wall of the recess when the first switch is being depressed. It thus becomes possible to prevent them from being displaced and provide a positive depressing feel in this push switch of the embodiment.

Furthermore, since second movable contact 30 is only the structure that differs from the conventional push switch showed in FIG. 6, it is easy to make common use of other components, manufacturing facilities, and the like.

Described next pertains to examples of certain variations of second movable contact 30.

Although second movable contact 30 of this embodiment described by referring to FIG. 2A has two connecting portions 33, it may be so altered that dome-shaped portion 31 and surrounding portion 32 are connected with three connecting portions 33, as shown in FIG. 2B and FIG. 2C. In other words, the number of connecting portions 33 needs not be restrictive. Besides, connecting portions 33 are not necessarily disposed at equal intervals. Here, FIG. 2B and FIG. 2C are a perspective view and a top view, respectively, of second movable contact 30.

FIG. 2D shown a top view of second movable contact 30 provided with four connecting portions 33.

Or, second movable contact 30 may be formed into a continuous piece without making any space between dome-shaped portion 31 and surrounding portion 32 by not providing connecting portions 33.

Description is provided further of another example of variation of second movable contact 30 with reference to FIG. 2E and FIG. 2F.

In this exemplary embodiment shown in FIG. 2A, surrounding portion 32 has a circular ring shape, and it encircles dome-shaped portion 31. However, surrounding portion 32 needs not necessarily have a circular ring shape. Surrounding portion 32 may instead be formed into a circular arc shape in a part of the peripheral region around dome-shaped portion 31, as shown in FIG. 2E and FIG. 2F.

### SECOND EXEMPLARY EMBODIMENT

Description is provided next of second exemplary embodiment. Since all what differ between the first exemplary embodiment and the second exemplary embodiment are shapes of connecting portions and dome-shaped portion of the second movable contact, description will be omitted for other structures that are identical to the first exemplary embodiment.

The second movable contact of the second exemplary embodiment is illustrated in FIG. 2G.

FIG. 2G is a top view of second movable contact 40. Dome-shaped portion 41 has such a shape that parts of its round edge are cut out inwardly in a plan view. These areas of the round edge that are cut out are referred to as cutout portions 41A and 41B. The dotted line is a phantom line of dome-shaped portion 41 if it is round, and the peripheral edge of dome-shaped portion 41 near connecting portions 43 is closer to the center of dome-shaped portion 41 than the dotted line, according to this embodiment.

One end of each of connecting portions 43 is connected to dome-shaped portion 41 in an area between cutout portions 41A and 41B. The other end of connecting portion 43 is joined to surrounding portion 42.

In other words, the connections between dome-shaped portion 41 and connecting portion 43 of second movable contact 40 shown in FIG. 2G are located closer to the center of dome-shaped portion 41 than to the center of dome-shaped portion 31 of second movable contact 30 shown in FIG. 2A through FIG. 2F. In second movable contact 40 shown in FIG. 2G, a lower end of the peripheral edge at each area of cutout portions 41A and 41B of dome-shaped portion 41 is located in a position higher than a lower end of the peripheral edge in areas other than the cutout portions (41A, etc.) of dome-shaped portion 41 when observed from the side.

According to the second exemplary embodiment, there is a space between the lower end of the peripheral edge at each area of cutout portions 41A and 41B of second movable contact 40 and first movable contact (10), whereas the lower end of the entire peripheral edge of dome-shaped portion 31 is in contact with first movable contact 10 in the case of the first exemplary embodiment as shown in FIG. 1. There also exists another space between connecting portion 43 and first movable contact (10).

In other words, when being depressed, the push switch provided with second movable contact 40 shown in FIG. 2G can keep second movable contact 40 from coming into contact with annular portion (12) of first movable contact (10).

Accordingly, the second exemplary embodiment has advantages of avoiding deformation of connecting portions 43 attributable to repeated operation of the switch and preventing undue stresses from being exerted on connecting portions 43, in addition to the advantages of the push switch of the first exemplary embodiment.

In the above exemplary embodiments, although description has been provided by using a double-action push switch, the scope of this invention is not limited only to the double-action push switch. It is with ease to make up a single-action push switch by using any of second movable contacts 30 and 40 of these exemplary embodiments.

Push switches according to the present invention have advantages of increasing an operating stroke and providing a positive feeling in depressing manipulation. In addition, the push switches of this invention are useful for input control sections and the like of various electronic apparatuses.

What is claimed is:

1. A push switch configured to cause a movable contact unit to deform elastically to establish continuity between a first stationary contact and a second stationary contact through the movable contact unit, the push switch comprising:
the first stationary contact;
the second stationary contact disposed apart from the first stationary contact; and
the movable contact unit confronting the first stationary contact with a space therebetween, wherein the movable contact unit has a center portion and a surrounding portion,
the center portion has a dome-like shape, and
the surrounding portion is formed along a peripheral region of the center portion.

2. The push switch of claim 1, wherein the surrounding portion encircles the center portion in a plan view.

3. The push switch of claim 1, wherein the movable contact unit further has a connecting portion connecting the center portion and the surrounding portion.

4. The push switch of claim 1, wherein the movable contact unit comprises:
a first movable contact; and
a second movable contact formed above the first movable contact, and including the center portion and the surrounding portion,
wherein a peripheral edge of the center portion abuts on the first movable contact.

5. The push switch of claim 1 further comprising a case,
wherein the first movable contact and the second movable contact are disposed inside a recess of the case, and
a peripheral edge of the first movable contact and a peripheral edge of the surrounding portion abut on an inner wall of the case.

6. The push switch of claim 3, wherein
the center portion has a round shape of which a part is cut out, and
the connecting portion is connected to the center portion at an area between two cutout portions, the area being the part where the round shape is cut out.
